(19) United States
(12) Patent Application Publication
(10) Pub. No.: US 2025/0334218 A1
(43) Pub. Date: Oct. 30, 2025

(54) CONNECTING MEMBER FOR CONNECTING MULTIFUNCTIONAL HIGH-STRENGTH PIPE WITH OTHER COMPONENTS

(71) Applicant: Ningbo Hyderon Hardware Co., Ltd., Yuyao (CN)

(72) Inventor: Lifeng ZHANG, Yuyao (CN)

(21) Appl. No.: 18/648,319

(22) Filed: Apr. 26, 2024

(51) Int. Cl. F16L 47/06; F16L 47/26

(52) U.S. Cl. CPC F16L 47/06; F16L 47/26

(57) ABSTRACT

A connecting member for connecting a multifunctional high-strength pipe with other components, includes an upper supporting plastic member, a lower supporting plastic member, a spring piece, and a shaft sleeve, the upper supporting plastic member and the lower supporting plastic member are jointly sleeved outside the shaft sleeve, an annular protruding block is arranged at the top end of the shaft sleeve, and one end of the upper supporting plastic member abuts against the annular protruding block, wherein a spring piece is arranged outside the shaft sleeve between the upper supporting plastic member and the lower supporting plastic member, thereby connecting a component needing to be connected with the steel pipe.

### TECHNICAL FIELD

This invention generally relates to the technical field of pipe connection, and more particularly, to a connecting member for connecting a multifunctional high-strength pipe with other components.

### BACKGROUND

In the prior art, the connection between pipes, as well as between a pipe and a component are always confronted with challenges. There are two conventional connection methods that are used most extensively: one method is to contract a pipe, reduce the outer diameter of the pipe, and then insert the pipe into another pipe. Although this method is capable of achieving the connection between pipes, the processing process is complex, and professional skills and equipment are needed. Meanwhile, after being contracted, the pipe has a poor lateral stress performance, resulting in loosening or damage such that the stability and safety of the entire system are lowered. The aforesaid connection method has a short lifespan and needs frequent maintenance and replacement, further increasing the cost of use.

Another conventional method is to weld nuts at a pipe mouth and then connect using bolts. By means of this method, the stability of the connection is improved to a certain extent. However, the welding process also needs professional skills and equipment, and the connection relies heavily on the welding quality. In addition, the welded connection is not aesthetically appealing and is easy to loosen or damage when a lateral force is imposed, resulting in poor stability and safety of the entire system. Therefore, it is urgent to develop a novel connection structure, which is capable of achieving rapid connection between pipes through simple operations such as sleeving and fastening.

### SUMMARY

The purpose of the present invention is to provide a connecting member for connecting a multifunctional high-strength pipe with other components.

To achieve the above purpose, the present invention adopts the following technical solution: a connecting member for connecting a multifunctional high-strength pipe with other components comprises an upper supporting plastic member, a lower supporting plastic member, a spring piece and a shaft sleeve, wherein the upper supporting plastic member and the lower supporting plastic member are jointly sleeved outside the shaft sleeve, wherein an annular protruding block is arranged at the top end of the shaft sleeve, and one end of the upper supporting plastic member abuts against the annular protruding block, wherein a spring piece is arranged outside the shaft sleeve between the upper supporting plastic member and the lower supporting plastic member, thereby connecting a component needing to be connected with the steel pipe.

In another preferred embodiment, an inner wall of the lower supporting plastic member is provided with a groove, an outer wall of the shaft sleeve is provided with a convex block for interacting with the groove. The outer wall of the lower supporting plastic member is provided with an annular supporting platform, and the annular supporting platform is clamped with the outer wall of the steel pipe.

In another preferred embodiment, the interior of the shaft sleeve is provided with an internal thread.

In another preferred embodiment, the periphery of the spring piece is provided with a plurality of arc-shaped elastic claws.

The present invention also provides the following technical solution: a connecting member for connecting a multifunctional high-strength pipe with other components comprises a first supporting plastic member, a second supporting plastic member, a spring piece, a metal supporting platform and a connecting screw rod, wherein the spring piece, the first supporting plastic member and the second supporting plastic member are jointly sleeved outside the connecting screw rod, a limiting block is arranged at the top end of the connecting screw rod, and the limiting block abuts against one side of the spring piece, wherein the other side of the spring piece is sleeved with the first supporting plastic member, one side of the first supporting plastic member is sleeved with another spring piece and the second supporting plastic member, wherein the bottom of the second supporting plastic member abuts against an outer wall of the metal supporting platform on the connecting screw rod, thereby allowing the steel pipe to be connected with a component needing to be connected.

In another preferred embodiment, a limiting ring is arranged on an outer wall of the connecting screw rod, the limiting ring is clamped with an inner wall of the metal supporting platform, and the metal supporting platform is clamped with an outer wall of the steel pipe.

In another preferred embodiment, the exterior of the connecting screw rod is provided with an external thread.

In another preferred embodiment, the periphery of the spring piece is provided with a plurality of arc-shaped elastic claws.

Compared with the prior art, the present invention has the following advantages:
1) The plastic reinforcing members interact with the inner wall of the steel pipe, so that the plastic members are firmly attached to the pipe wall; due to the increased contact area with the pipe wall of the steel pipe, the lateral stress performance is greatly improved;
2) The spring piece has high strength and high toughness and is capable of being firmly clamped with the steel pipe, thereby improving the pulling force borne by the product;
3) The plastic supporting structure significantly improves the lateral stress performance after the pipes are connected;
4) The design with built-in bolts and nuts makes the assembly simpler and more convenient, which does not need tools during assembly.

### BRIEF DESCRIPTION OF THE DRAWINGS

FIG. 1 is a schematic diagram illustrating a front view of the overall structure in embodiment 1 of the present invention;

FIG. 2 is a schematic diagram illustrating an assembled structure in embodiment 1 of the present invention;

FIG. 3 is a schematic diagram illustrating a sectional view of the structure clamped with the steel pipe in embodiment 1 of the present invention;

FIG. 4 is a schematic diagram illustrating a sectional view along line A-A in embodiment 1 of the present invention;

FIG. 5 is a schematic diagram illustrating a front view of the overall structure in embodiment 2 of the present invention;

FIG. 6 is a schematic diagram illustrating an assembled structure in embodiment 2 of the present invention;

FIG. 7 is a schematic diagram illustrating a sectional view of the structure clamped with the steel pipe in embodiment 2 of the present invention;

In Figures: 1—Upper Supporting Plastic member, 2—Lower Supporting Plastic member, 3—Spring Piece, 4—Shaft Sleeve, 5—Annular Protruding Block, 6—The First Supporting Plastic member, 7—The Second Supporting Plastic member, 8—Metal Supporting Platform, 9—Connecting Screw Rod, 10—Limiting Block, 11—Groove, 12—Convex Block, 13—Annular Supporting Platform, 14—Steel Pipe, 15—Limiting Ring, 16—Internal Thread, 17—External Thread, 18—Elastic Claw.

### DETAILED DESCRIPTION

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### Embodiment 1

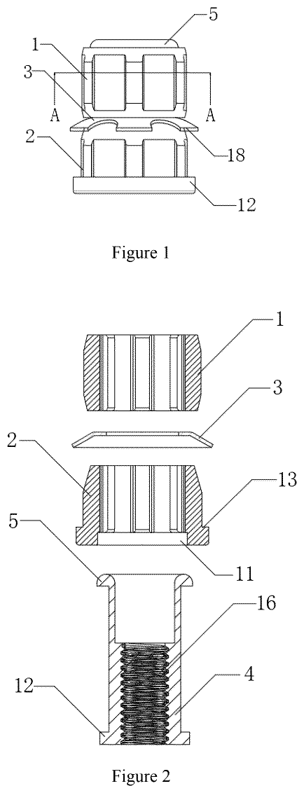

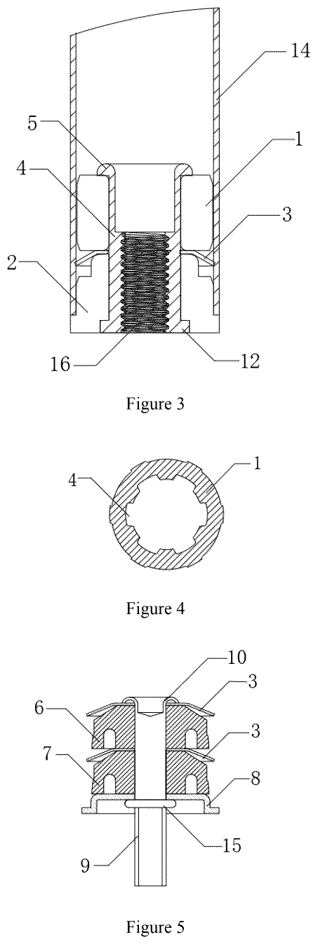

Referring to FIGS. 1-4, the present invention provides a connecting member for connecting a multifunctional high-strength pipe with other components. The connecting member for connecting a multifunctional high-strength pipe with other components of the present invention comprises an upper supporting plastic member 1, a lower supporting plastic member 2, a spring piece 3 and a shaft sleeve 4, wherein the upper supporting plastic member 1 and the lower supporting plastic member 2 are jointly sleeved outside the shaft sleeve 4. The size of the supporting plastic member is configured to be 1 mm (millimeter) larger than the inner diameter of the steel pipe, and the supporting plastic member is provided with a groove structure for enhancing its adaptability. Its unique contraction function allows it to adapt to wall thickness of different steel pipes, and the elastic deformation enables it to be tightly attached to the inner wall of the steel pipe, thereby significantly improving the lateral stress performance. An annular protruding block 5 is arranged at the top end of the shaft sleeve 4, and one end of the upper supporting plastic member 1 abuts against the annular protruding block 5, so that the upper supporting plastic member 1 and the shaft sleeve 4 are relatively fixed. The spring piece 3 is arranged outside the shaft sleeve 4 between the upper supporting plastic member 1 and the lower supporting plastic member 2, thereby connecting a component needing to be connected with the steel pipe 14, for example, a screw rod or an inserting rod. When the connecting member bears an external force, the elastic action of the spring piece 3 provides a certain buffering to the connecting member while ensuring a tight connection between the connecting member and the steel pipe 14. Moreover, the outer diameter of the spring piece is 1.2 mm (millimeter) larger than the inner diameter of the steel pipe 14, and the spring piece 14 is capable of firmly clamping the pipe wall after being hammered into the steel pipe 14, thereby achieving the function of connecting with the steel pipe 14.

More specifically, an inner wall of the lower supporting plastic member 2 is provided with a groove 11, an outer wall of the shaft sleeve 4 is provided with a convex block 12 for interacting with the groove 11. The outer wall of the lower supporting plastic member 2 is provided with an annular supporting platform 13, and the annular supporting platform 13 is clamped with the outer wall of the steel pipe 14. Through adopting the aforesaid design, the supporting plastic member is firmly attached to the pipe wall of the steel pipe 14, the contact area with the pipe wall of the steel pipe 14 is increased, and the lateral stress performance is greatly improved. The shaft sleeve 4 is internally provided with an internal thread 16, which allows the shaft sleeve to be screwed with a component with an external thread.

More specifically, the periphery of the spring piece 3 is provided with a plurality of arc-shaped elastic claws 18.

In this embodiment, by means of the combination of the upper supporting plastic member 1, the lower supporting plastic member 2 and the shaft sleeve 4, the inner wall of the steel pipe 14 is clamped by the arc-shaped elastic claws 18 arranged on the periphery of the spring piece 3. Moreover, the shaft sleeve 4 is provided with an internal thread 16, which allows the connecting member to be connected with a component with an external thread, for example, a screw rod or an inserting rod. This connection way not only widens the application range of the connecting member but also improves its adaptability. Conventional connecting members normally merely adapt to steel pipes with a single specification, for example, a steel pipe with a diameter of 25 mm (millimeters) and a wall thickness of 1.2 mm (millimeters). Through adopting the present invention, the connecting member may adapt to steel pipes with various specifications, such as steel pipes with a diameter of 25 mm (millimeters) and a wall thickness ranging from 1.2 to 1.5 mm (millimeters). The aforesaid design not only enhances the universality and flexibility of the connecting member, but also greatly simplifies the assembly and disassembly. Therefore, the operating efficiency is significantly improved.

### Embodiment 2

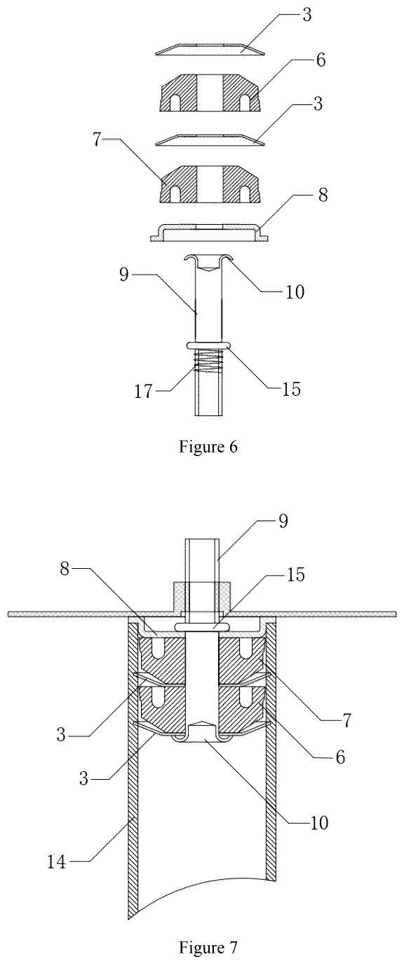

Referring to FIGS. 5-7, the present invention provides another technical solution: in this embodiment, the connecting member for connecting a multifunctional high-strength pipe with other components comprises a first supporting plastic member 6, a second supporting plastic member 7, a spring piece 3, a metal supporting platform 8 and a connecting screw rod 9, wherein the spring piece 3, the first supporting plastic member 6 and the second supporting plastic member 7 are jointly sleeved outside the connecting screw rod 9, a limiting block 10 is arranged at the top end of the connecting screw rod 9, and the limiting block 10 abuts against one side of the spring piece 3. The other side of the spring piece 3 is sleeved with the first supporting plastic member 6, one side of the first supporting plastic member 6 is sleeved with another spring piece 3 and the second supporting plastic member 7. The bottom of the second supporting plastic member 7 abuts against an outer wall of the metal supporting platform 8 on the connecting screw rod 9, thereby allowing the steel pipe 14 to be connected with a component needing to be connected, such as a nut, a bolt, or a component with an internal thread.

More specifically, a limiting ring 15 is arranged on an outer wall of the connecting screw rod 9, the limiting ring 15 is clamped with an inner wall of the metal supporting platform 8, and the metal supporting platform 8 is clamped with an outer wall of the steel pipe 14.

More specifically, the exterior of the connecting screw rod 9 is provided with an external thread, which allows the connecting screw rod 9 to be screwed with a component with an internal thread.

More specifically, the size of the supporting plastic member is 1 mm (millimeter) greater than the inner diameter of the steel pipe 14, and the supporting plastic member is provided with a groove structure and is capable of contracting. By means of the contraction function, the contracting adjustment is performed based on different wall thicknesses such that high adaptability is achieved. After being hammered into the steel pipe 14, the supporting piece is capable of being tightly attached to the inner wall of the steel pipe 14, thereby improving the lateral stress performance. This adjustment is achieved by the elastic property of the plastic material, and when bearing an external force, the supporting plastic member elastically deforms to adapt to the shape and size of the inner wall of the steel pipe 14.

More specifically, the plurality of arc-shaped elastic claws 18 are arranged on the periphery of the spring piece 3, and the elastic claws 18 possess certain elasticity and bendability. By means of the aforesaid design, when being sleeved on the screw rod, the elastic claws 18 are capable of adapting to screw rods with different diameters and providing a reliable clamping force. The aforesaid design prevents the elastic piece from loosening or falling off from the screw rod while ensuring high stability and reliability of the connection.

Compared with embodiment 1, in this embodiment, there are two spring pieces 3, which provide stronger support while achieving higher stability. The first supporting plastic member 6 and the second supporting plastic member 7 are jointly sleeved outside the connecting screw rod 9 for not only fixing and supporting the spring pieces 3 but also protecting the connected components. In this way, the abrasion and corrosion are effectively reduced. When the connecting screw rod 9 is tightened, the two spring pieces 3 elastically deform. The outer diameter of the spring piece 3 is 1.2 mm (millimeters) greater than the inner diameter of the steel pipe. After the spring pieces 3 are hammered into the steel pipe, the pipe wall of the steel pipe is tightly clamped by the spring pieces 3, thereby achieving the function of connecting with the steel pipe 14. Thus, a tight connection between the high-strength pipe and other components is ensured. The aforesaid design not only enhances the stability and reliability of the connection, but also achieves the fine tuning of the connection such that the requirements of various sizes and shapes are met. In this embodiment, the metal supporting platform 8 and the supporting plastic member are separated, making the structure of the connecting member more flexible. Moreover, the limiting ring is located on the outer wall of the connecting screw rod 9 and is clamped with the inner wall of the metal supporting platform 8. Through adopting the aforesaid design, the correct position of the metal supporting platform 8 in the connecting process is ensured, effectively preventing the metal supporting platform 8 from rotating or moving while further enhancing the stability of the connection.

In addition, in this embodiment, the shaft sleeve 4 is replaced by using a connecting screw rod 9, and one end of the screw rod is provided with a limiting block 10 for limiting the spring piece 3, thereby ensuring that the spring piece 3 is always in the correct position. The other end of the screw rod is provided with the external thread 17, thereby allowing the screw rod to be connected with a component with the internal thread. This design enables the connecting member to be conveniently connected and fixed to various components, significantly improving the universality and flexibility of the connection.

In the present invention, the undescribed parts belong to the prior art.

Although embodiments of the present invention are described, for those skilled in the art, various changes, modifications and replacements may be made based on these embodiments without departing from the principles and spirit of the present invention. Therefore, and the scope of the present invention is defined by the claims and their equivalents.

1. A connecting member for connecting a multifunctional high-strength pipe with other components, comprising:
an upper supporting plastic member (1),
a lower supporting plastic member (2),
a spring piece (3), and
a shaft sleeve (4), wherein the upper supporting plastic member (1) and the lower supporting plastic member (2) are jointly sleeved outside the shaft sleeve (4), wherein an annular protruding block (5) is arranged at the top end of the shaft sleeve (4), and one end of the upper supporting plastic member (1) abuts against the annular protruding block (5), wherein a spring piece (3) is arranged outside the shaft sleeve (4) between the upper supporting plastic member (1) and the lower supporting plastic member (2), thereby connecting a component needing to be connected with the steel pipe (14).

2. The connecting member for connecting a multifunctional high-strength pipe with other components of claim 1, wherein an inner wall of the lower supporting plastic member (2) is provided with a groove (11), and an outer wall of the shaft sleeve (4) is provided with a convex block (12) for interacting with the groove (11), wherein an outer wall of the lower supporting plastic member (2) is provided with an annular supporting platform (13), and the annular supporting platform (13) is clamped with an outer wall of the steel pipe (14).

3. The connecting member for connecting a multifunctional high-strength pipe with other components of claim 1, wherein the interior of the shaft sleeve (4) is provided with an internal thread.

4. The connecting member for connecting a multifunctional high-strength pipe with other components of claim 1, wherein the periphery of the spring piece (3) is provided with a plurality of arc-shaped elastic claws (18).

5. A connecting member for connecting a multifunctional high-strength pipe with other components, comprising:
a first supporting plastic member (6),
a second supporting plastic member (7),
a spring piece (3),
a metal supporting platform (8), and
a connecting screw rod (9), wherein the spring piece (3), the first supporting plastic member (6) and the second supporting plastic member (7) are jointly sleeved outside the connecting screw rod (9), wherein a limiting block (10) is arranged at a top end of the connecting screw rod (9), and the limiting block (10) abuts against one side of the spring piece (3), wherein another side of the spring piece (3) is sleeved with the first supporting plastic member (6), and one side of the first supporting plastic member (6) is sleeved with another spring piece (3) and the second supporting plastic member (7), wherein the bottom of the second supporting plastic member (7) abuts against an outer wall of the metal supporting platform (8) on the connecting screw rod (9), thereby allowing the steel pipe (14) to be connected with a component needing to be connected.

6. The connecting member for connecting a multifunctional high-strength pipe with other components of claim 5, wherein a limiting ring (15) is arranged on an outer wall of the connecting screw rod (9), wherein the limiting ring (15) is clamped with an inner wall of the metal supporting platform (8), and wherein the metal supporting platform (8) is clamped with an outer wall of the steel pipe (14).

7. The connecting member for connecting a multifunctional high-strength pipe with other components of claim 5, wherein the exterior of the connecting screw rod (9) is provided with an external thread.

8. The connecting member for connecting a multifunctional high-strength pipe with other components of claim 5, wherein the periphery of the spring piece (3) is provided with a plurality of arc-shaped elastic claws (18).
